(19) United States
(12) Patent Application Publication
(10) Pub. No.: US 2018/0300740 A1
(43) Pub. Date: Oct. 18, 2018

(54) PREDICTING COST OF AN INFRASTRUCTURE STACK DESCRIBED IN A TEMPLATE

(71) Applicant: International Business Machines Corporation, Armonk, NY (US)

(72) Inventors: Shiva P. Chandrashekar, BANGALORE (IN); Ashoka S. Rao, BANGALORE (IN); Sreekrishnan Venkiteswaran, BANGALORE (IN)

(21) Appl. No.: 15/485,297

(22) Filed: Apr. 12, 2017

(51) Int. Cl. G06Q 30/02; G06Q 30/04

(52) U.S. Cl. CPC G06Q 30/0206; G06Q 30/04

(57) ABSTRACT

A method, a computer program product, and a computer system for predicting cost of an infrastructure stack described in a template. A computer receives from a user the template that describes the infrastructure stack. The computer analyzes information in the template, maps the information to a set of attributes, and simulates based on the attributes an infrastructure model depicting the infrastructure stack. The computer applies a predefined costing model to the infrastructure model. The computer produces estimated billing for the cost of the infrastructure stack, ahead of provisioning the infrastructure stack.

### BACKGROUND

The present invention relates generally to predicting cost of an infrastructure stack, and more particularly to predicting cost of an infrastructure stack described in a template ahead of provisioning.

In a previous disclosure, the estimation of cloud computing resource costs required to process a workload to be completed uses at least two different cloud computing models. In another previous disclosure, the cloud estimator tool determines a performance estimate and a cost estimate for the cloud computing configuration based on the hardware parameters and the computing load parameters characterized in the server configuration profile and the load profile. In yet another previous disclosure, determining the cloud services offering price for a particular one of the cloud service offerings includes mapping the cloud services architecture specification to cloud service pricing information for the particular one of the cloud service offerings. A previous disclosure provides a cost analysis tool enabling the user to estimate an application configuration and provide a business-ready analysis report of the components costs based on the configuration that complies with corporate governance. Another disclosure presents a service for estimating and monitoring costs for computational applications in cloud computing environments; the cost estimation service is developed using cost models and monitoring data for a set of predefined applications.

### SUMMARY

In one aspect, a method for predicting cost of an infrastructure stack described in a template is provided. The method is implemented by a computer. The method comprises receiving from a user the template, wherein the template describes the infrastructure stack. The method further comprises analyzing information in the template, mapping the information to a set of attributes, and simulating based on the attributes an infrastructure model depicting the infrastructure stack. The method further comprises applying a predefined costing model to the infrastructure model. The method further comprises producing estimated billing for the cost of the infrastructure stack, ahead of provisioning the infrastructure stack.

In another aspect, a computer program product for predicting cost of an infrastructure stack described in a template is provided. The computer program product comprises a computer readable storage medium having program code embodied therewith. The program code is executable to receive from a user, by a computer, the template, wherein the template describes the infrastructure stack. The program code is further executable to analyze, by the computer, information in the template. The program code is further executable to map, by the computer, the information to a set of attributes. The program code is further executable to simulate, by the computer, an infrastructure model depicting the infrastructure stack, based on the attributes. The program code is further executable to apply, by the computer, a predefined costing model to the infrastructure model. The program code is further executable to produce, by the computer, estimated billing for the cost of the infrastructure stack, ahead of provisioning the infrastructure stack.

In yet another aspect, a computer system for predicting cost of an infrastructure stack described in a template is provided. The computer system comprises one or more processors, one or more computer readable tangible storage devices, and program instructions stored on at least one of the one or more computer readable tangible storage devices for execution by at least one of the one or more processors. The program instructions are executable to receive from a user, by a computer, the template, wherein the template describes the infrastructure stack; analyze, by the computer, information in the template; map, by the computer, the information to a set of attributes; simulate, by the computer, an infrastructure model depicting the infrastructure stack, based on the attributes; apply, by the computer, a predefined costing model to the infrastructure model; and produce, by the computer, estimated billing for the cost of the infrastructure stack, ahead of provisioning the infrastructure stack.

### BRIEF DESCRIPTION OF THE SEVERAL VIEWS OF THE DRAWINGS

FIG. 1 is a diagram illustrating a system for predicting cost of a cloud infrastructure stack described in a template ahead of the actual provisioning, in accordance with one embodiment of the present invention.

FIG. 2(A) and 2(B) present a flowchart showing operational steps for predicting cost of a cloud infrastructure stack described in a template ahead of actual provisioning, in accordance with one embodiment of the present invention.

FIG. 3 is a diagram illustrating an example of a simulated output stack, in accordance with one embodiment of the present invention.

FIG. 4 is a diagram illustrating an example of estimated billing for cost of a cloud infrastructure stack described in a template ahead of actual provisioning, in accordance with one embodiment of the present invention.

FIG. 5 is a diagram illustrating components of a computer device for predicting cost of a cloud infrastructure stack described in a template ahead of actual provisioning, in accordance with one embodiment of the present invention.

FIG. 6 depicts a cloud computing environment, in accordance with one embodiment of the present invention.

FIG. 7 depicts abstraction model layers in a cloud computing environment, in accordance with one embodiment of the present invention.

### DETAILED DESCRIPTION

As enterprises are moving into cloud computing, deployments and configurations of virtual machines and application software become more complex. The solution to this problem is automating the deployments and configurations using templates. A template describes a cloud infrastructure stack for a cloud application in a text file with infrastructure resources that make up the cloud infrastructure stack. A template includes several major constructs, such as resources to define the computing resources, parameters to pass values to the template during runtime, conditions to define whether certain resources are created, and auto scaling that ensures that there are correct number of instances available to handle the load. The template may include several other constructs.

Templates can be classified as simple or complex based on the type of constructs inside them. In a simple template with no input parameters, conditional logic, or auto scaling, it is easier to visualize the resources that are created upon deploying the template as the resulting cloud infrastructure stack is static. However, in a complex template which accepts parameters and has conditional logic or auto scaling constructs, it is not easy to visualize the infrastructure topology as the resulting cloud infrastructure stack is dynamic. Under such a circumstance, predicting the cost of the cloud infrastructure stack is extremely difficult.

In order to overcome the problem in predicting the cost for complex templates, the embodiments of the present invention present a system that can easily predict the cost of a cloud infrastructure stack before its creation. This system predicts the cost by simulating the outcome of a template based on a set of variables such as input parameters, resources, conditional logic, and auto scaling.

The system with its prediction capabilities helps consumers of cloud computing to plan their cloud infrastructures that suits their business, budget, and other financial planning. The system also helps consumers to choose right vendors by comparing the estimated costs of various vendors. The system helps to identify the optimal amount of cloud infrastructure required to meet the anticipated needs of customers or users. After visualizing the estimated cost of the infrastructure, cloud consumers can define their cloud migration strategy.

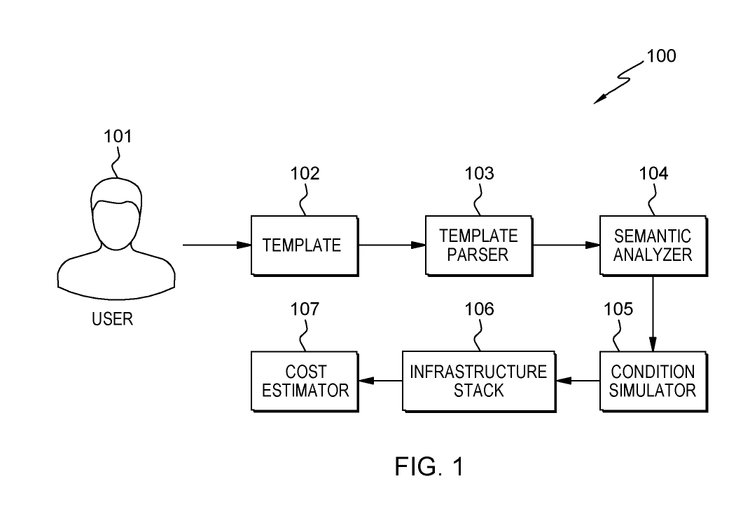

FIG. 1 is a diagram illustrating system 100 for predicting cost of a cloud infrastructure stack described in a template ahead of actual provisioning, in accordance with one embodiment of the present invention. System 100 includes template parser 103, semantic analyzer 104, condition simulator 105, and cost estimator 107. Upon receiving template 102 submitted by user 101, template parser 103 scans template 102 and checks grammar and syntax errors. Template parser 103 checks a parameters section in template 102 to determine input parameters that will be used in a condition section in template 102. For example, the input parameters include a VM (Virtual Machine) count, VM memory, and VM disk size. Template parser 103 checks the condition section in template 102. Template parser 103 maps the parameters used in the condition section with the parameters defined in the parameters section. Template parser 103 reads different user-defined parameter values and an associated conclusion. The conclusion part has details of resources that are created when the condition evaluates to true. Template parser 103 constructs a parse tree by mapping the read information to a set of attributes. Then, template parser 103 passes parsed information to semantic analyzer 104.

Receiving the parsed information from template parser 103, semantic analyzer 104 extracts the attributes from the parse tree. Semantic analyzer 104 breaks compute information to CPU, disk, and memory. Semantic analyzer 104 initializes JSON objects. Semantic analyzer 104 sets the region attribute in the JSON objects. Semantic analyzer 104 sets JSON objects with the attributes representing resources that are used in simulating the output stack. Semantic analyzer 104 reads auto scaling groups. Semantic analyzer 104 extracts minimum and maximum numbers of instances from the parse tree. Semantic analyzer 104 sets instances in the JSON objects. Semantic analyzer 104 passes the JSON objects to the condition simulator 105.

Condition simulator 105 enables prediction of the behavior of the cloud computing infrastructure from a set of parameters and resources information. Condition simulator 105 analyzes the parameters and resources information from the attributes received from semantic analyzer 104. Condition simulator 105 simulates different parameter values. Condition simulator 105 simulates different conditions to true and simulates resource creation in a region selected by user 101. The simulated output depicts infrastructure stack 106 with the minimum number of instances as mentioned in the auto scaling groups before scaling out, and the simulated output depicts infrastructure stack 106 with the maximum number of instances during scaling out. A simulated model is passed from condition simulator 105 to cost estimator 107.

Cost estimator 107 receives the simulated model from condition simulator 105. Cost estimator 107 includes a pre-defined costing model. The pricing is based on the region selected by user 101 and the consumption of various resources such as CPU, disk, memory, network, and volume. Cost estimator 107 applies the pre-defined costing model to the simulated model for estimating the costs. Cost estimator 107 produces estimated billing for a cost of infrastructure stack 106 ahead of actual provisioning.

Consider a template with the following definitions. These definitions state how resources should be created under different contexts production, development, or test and scaling information to maintain application availability.
“Parameters”: {“EnvType”: {“Description”: “Environment type.”, “Default”: “test”, “Type”: “String”, “AllowedValues”: [“prod”, “dev”, “test”], “ConstraintDescription”: “must specify prod, dev, or test.”}}, “Conditions”: {“CreateProdResources”: {“Fn::Equals”: [{“Ref”: “EnvType”}, “prod”]}, “CreateDevResources”: {“Fn::Equals”: [{“Ref”: “EnvType”}, “dev”]}},
“Resources”: {“EC2Instance”: {“Type”: “AWS::EC2::Instance”, “Properties”: {“ImageId”: {“Fn::FindInMap”: [“RegionMap”, {“Ref”: “AWS::Region”}, “AMI”]}, “InstanceType”: {“Fn::If”: [“CreateProdResources”, “c1.xlarge”, {“Fn::If”: [“CreateDevResources”, “m1.small”]}]}}},
“NewVolume”: {“Type”: “AWS::EC2::Volume”, “Condition”: “CreateProdResources”, “Properties”: {“Size”: “100”, “AvailabilityZone”: {“Fn::GetAtt”: [“EC2Instance”, “AvailabilityZone”]}}“MyServerGroup”: {“Type”: “AWS::AutoScaling::AutoScalingGroup”, “Properties”: {“AvailabilityZones”: {“Fn::GetAZs” “LaunchConfigurationName”: {“Ref”: “SimpleConfig”}, “MinSize”: “1”, “MaxSize”: “3”, “LoadBalancerNames”: [{“Ref”: “LB”}]}},

Parameters: This section defines the various input parameters that are evaluated in the conditions.

Conditions: This section defines conditions that determine how the resources are created.

Resources: This section defines details of the resources that are created.

AutoScaling: This section defines describes scaling information.

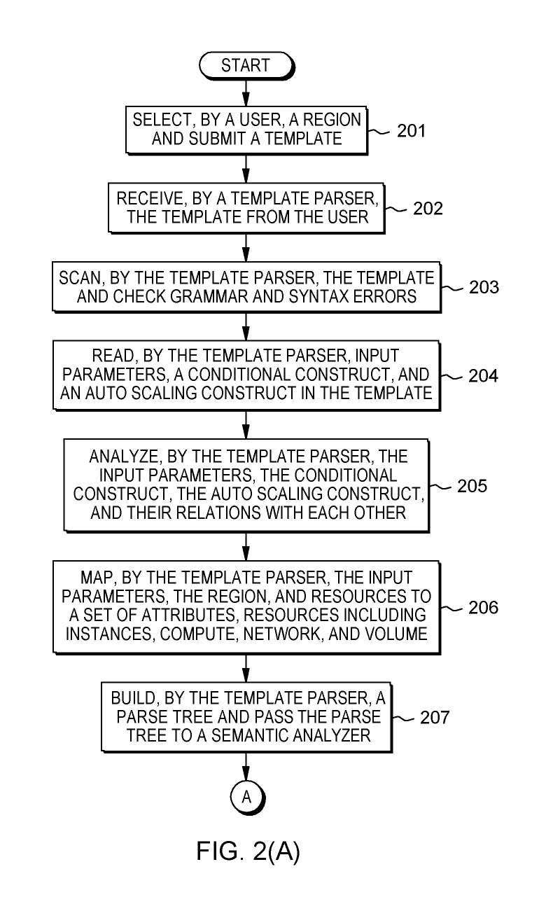

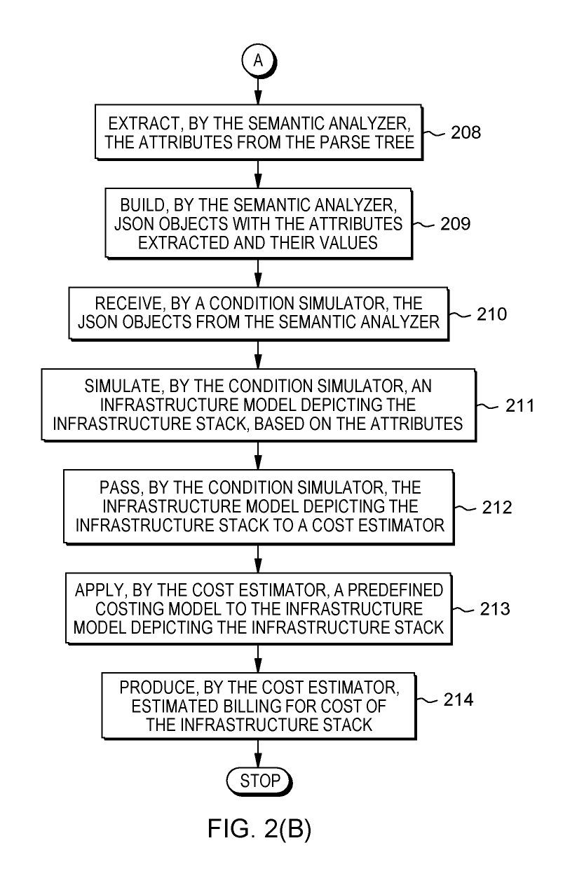

FIG. 2(A) and 2(B) present a flowchart showing operational steps for predicting cost of a cloud infrastructure stack described in a template ahead of actual provisioning, in accordance with one embodiment of the present invention. Referring to FIG. 2(B), at step 201, user 101 selects a region and submits template 102. At step 202, template parser 103 receives template 102 from user 101. At step 203, template parser 103 scans template 102 and checks grammar and syntax errors in template 102. At step 204, template parser 103 reads inputs parameters, a conditional construct, and an auto scaling construct in template 102. At step 205, template parser 103 analyzes the input parameters, the condition auto scaling construct, the auto scaling construct, and their relations with each other. At step 206, template parser 103 maps the input parameters, the region, and resources to a set of attributes. The resources include, for example, instances, compute, network, and volume. At step 207, template parser 103 builds a parse tree and passes the parse tree to semantic analyzer 104.

Referring to FIG. 2(B), at step 208, in response to receiving the parse tree, semantic analyzer 104 extracts the attributes from the parse tree. At step 209, semantic analyzer 104 builds JSON objects with the attributes extracted and their values. Then, semantic analyzer 104 passes the JSON objects to condition simulator 105.

Referring to FIG. 2(B), at step 210, condition simulator 105 receives the JSON objects from semantic analyzer 104. At step 211, based on the attributes, condition simulator 105 simulates an infrastructure model depicting infrastructure stack 106. At step 212, condition simulator 105 passes the simulated infrastructure model to cost estimator 107.

Referring to FIG. 2(B), at step 213, cost estimator 107 applies a predefined costing model to infrastructure stack 106. At step 214, cost estimator 107 produces estimated billing for a cost of infrastructure stack 106 ahead of actual provisioning.

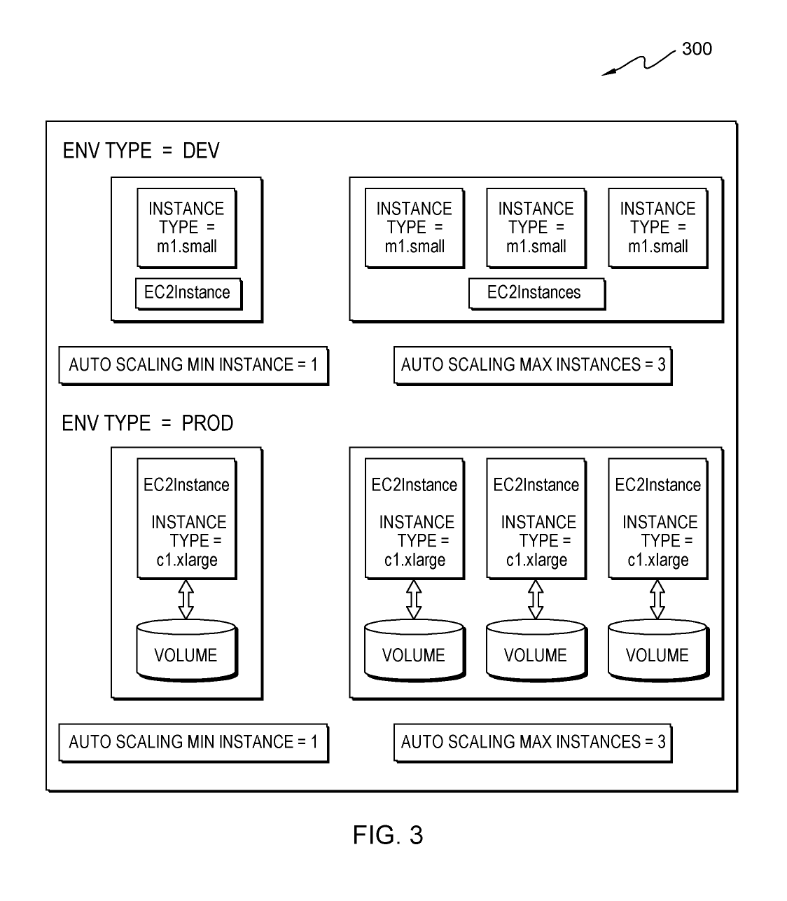

FIG. 3 is a diagram illustrating an example of simulated output stack 300, in accordance with one embodiment of the present invention. Simulated output stack 300 is a resulting cloud infrastructure stack that is created as a result of the template execution. In FIG. 3, “EnvType” is an input parameter. Shown in this example, the value of the input parameter is prod, dev, or test values. The input parameter in the template can be any other values. After template parser 103 scans template 102, semantic analyzer 104 maps these values to output variables. Semantic analyzer 104 maps resources instance type and volume to the variables. Semantic analyzer 104 maps instance type information “c1.xlarge” to output variable when “EnvType” is prod. Semantic analyzer 104 maps instance type information “m1.small” to output variable when “EnvType” is dev. Semantic analyzer 104 also sets properties of “NewVolume” representing volume information to output variables when “EnvType” is prod.

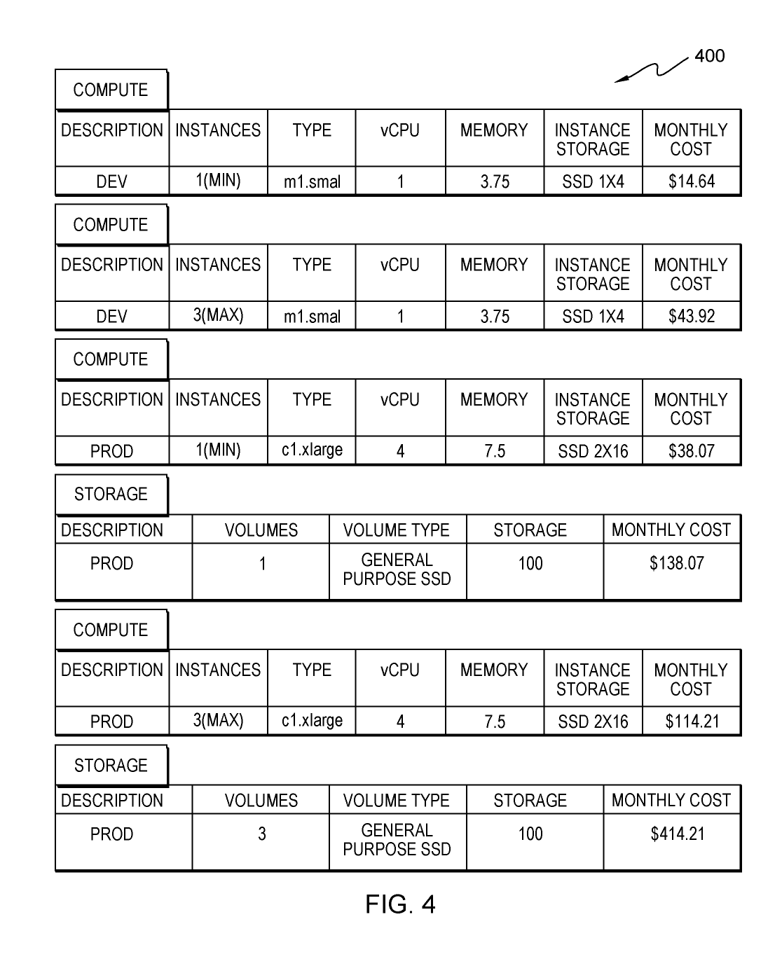

FIG. 4 is a diagram illustrating an example of estimated billing 400 for a cost of a cloud infrastructure stack described in a template ahead of actual provisioning, in accordance with one embodiment of the present invention. In the example, estimated billing 400 includes the cost of simulated output stack 300 shown in FIG. 3.

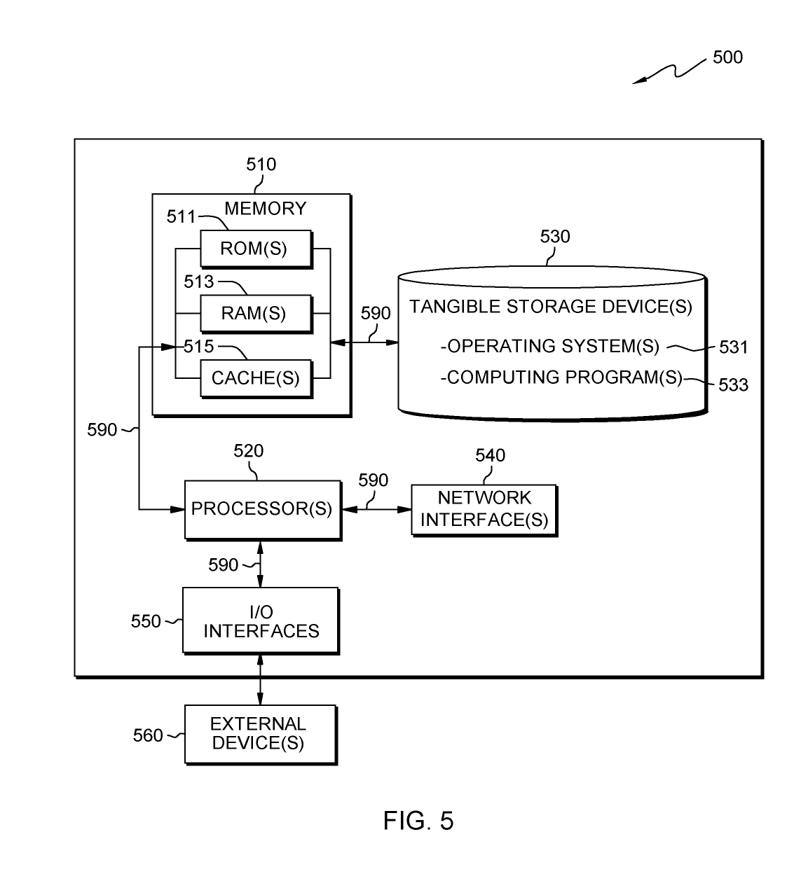

FIG. 5 is a diagram illustrating components of computer device 500 for predicting cost of a cloud infrastructure stack described in a template ahead of actual provisioning, in accordance with one embodiment of the present invention. It should be appreciated that FIG. 5 provides only an illustration of one implementation and does not imply any limitations with regard to the environment in which different embodiments may be implemented. The computer device may be any electronic device or computing system capable of receiving input from a user, executing computer program instructions, and communicating with another electronic device or computing system via a network.

Referring to FIG. 5, computer device 500 includes processor(s) 520, memory 510, and tangible storage device(s) 530. In FIG. 5, communications among the above-mentioned components of computer device 500 are denoted by numeral 590. Memory 510 includes ROM(s) (Read Only Memory) 511, RAM(s) (Random Access Memory) 513, and cache(s) 515. One or more operating systems 531 and one or more computer programs 533 reside on one or more computer readable tangible storage device(s) 530. Template parser 103, semantic analyzer 104, condition simulator 105, and cost estimator 107 reside on one or more computer readable tangible storage device(s) 530. Computer device 500 further includes I/O interface(s) 550. I/O interface(s) 550 allows for input and output of data with external device(s) 560 that may be connected to computer device 500. Computer device 500 further includes network interface(s) 540 for communications between computer device 500 and a computer network.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, and conventional procedural programming languages, such as the “C” programming language, or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

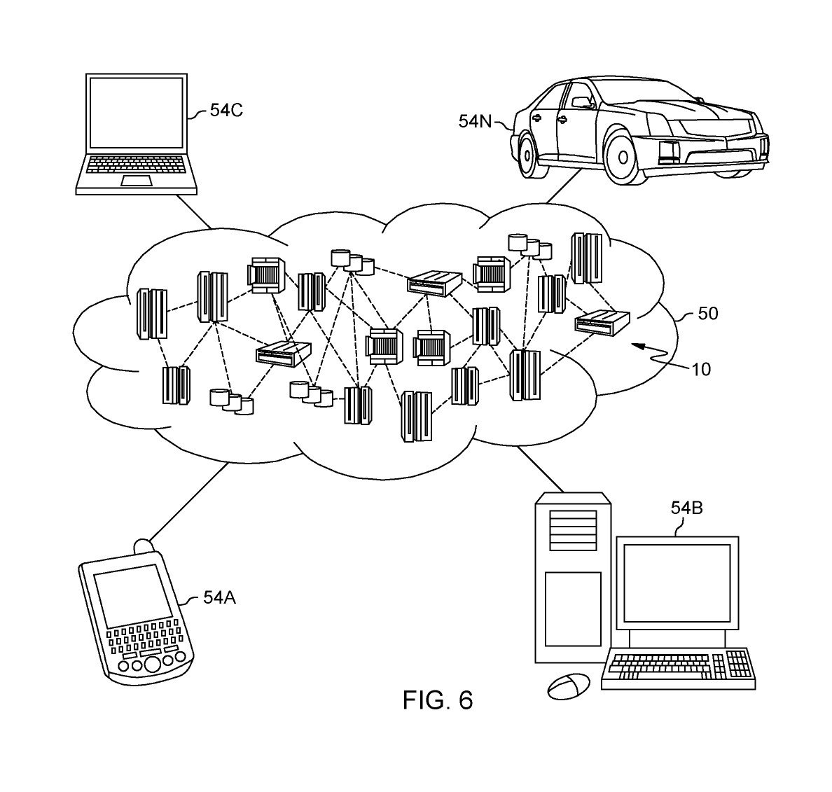

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

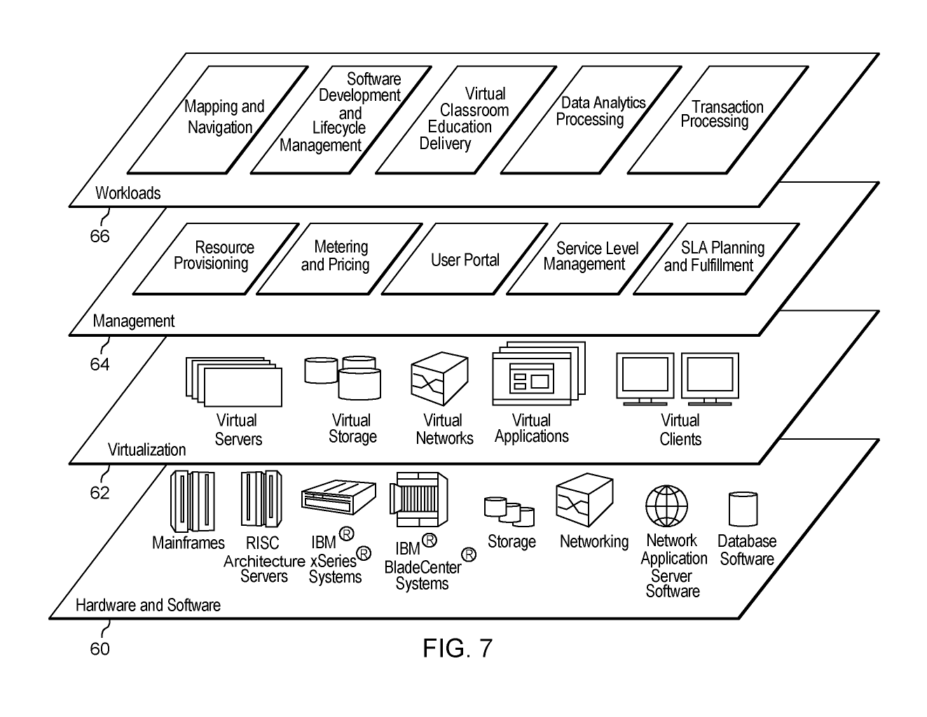

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes, RISC (Reduced Instruction Set Computer) architecture based servers, servers, blade servers, storage devices, and networks and networking components. In some embodiments, software components include network application server software and database software.

Virtualization layer 62 provides an abstraction layer from which the following examples of virtual entities may be provided: virtual servers, virtual storage, virtual networks, including virtual private networks, virtual applications and operating systems, and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may include application software licenses. Security provides identity verification for cloud consumers and tasks, as well as protection for data and other resources. User Portal provides access to the cloud computing environment for consumers and system administrators. Service Level Management provides cloud computing resource allocation and management such that required service levels are met. Service Level Agreement (SLA) Planning and Fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: Mapping and Navigation, Software Development and Lifecycle Management, Virtual Classroom Education Delivery, Data Analytics Processing, and Transaction Processing.

What is claimed is:

1. A method for predicting cost of an infrastructure stack described in a template, the method comprising:
receiving from a user, by a computer, the template, the template describing the infrastructure stack;
analyzing, by the computer, information in the template;
mapping, by the computer, the information to a set of attributes;
simulating, by the computer, an infrastructure model depicting the infrastructure stack, based on the attributes;
applying, by the computer, a predefined costing model to the infrastructure model; and
producing, by the computer, estimated billing for the cost of the infrastructure stack, ahead of provisioning the infrastructure stack.

2. The method of claim 1, further comprising:
scanning, by the computer, the template;
checking, by the computer, grammar and syntax errors in the template; and
reading, by the computer, input parameters, resources, a conditional construct, and an auto scaling construct in the template.

3. The method of claim 1, further comprising:
building, by the computer, a parse tree including the attributes;
passing, by the computer, the parse tree from a template parser to a semantic analyzer;
extracting, by the computer, the attributes from the parse tree;
building, by the computer, JSON objects with the attributes and values thereof;
passing, by the computer, the JSON objects from the semantic analyzer to a condition simulator; and
passing, by the computer, the infrastructure model from the condition simulator to a cost estimator.

4. The method of claim 1, wherein the information of the template comprises constructs of resources, parameters, conditions, and auto scaling, wherein the resources define computing resources, the parameters pass values to the template during runtime, the conditions define whether certain ones of the resources are created, and the auto scaling ensures a correct number of instances available.

5. The method of claim 4, wherein the resources comprises instances, compute, network, and volume.

6. The method of claim 4, wherein the parameters comprise a VM CPU count, VM memory, and VM disk size.

7. A computer program product for predicting cost of an infrastructure stack described in a template, the computer program product comprising a computer readable storage medium having program code embodied therewith, the program code executable to:
receive from a user, by a computer, the template, the template describing the infrastructure stack;
analyze, by the computer, information in the template;
map, by the computer, the information to a set of attributes;
simulate, by the computer, an infrastructure model depicting the infrastructure stack, based on the attributes;
apply, by the computer, a predefined costing model to the infrastructure model; and
produce, by the computer, estimated billing for the cost of the infrastructure stack, ahead of provisioning the infrastructure stack.

8. The computer program product of claim 7, further comprising the program code executable to:
scan, by the computer, the template;
checking, by the computer, grammar and syntax errors in the template; and
read, by the computer, input parameters, resources, a conditional construct, and an auto scaling construct in the template.

9. The computer program product of claim 7, further comprising the program code executable to:
build, by the computer, a parse tree including the attributes;
pass, by the computer, the parse tree from a template parser to a semantic analyzer;
extract, by the computer, the attributes from the parse tree;
build, by the computer, JSON objects with the attributes and values thereof;
pass, by the computer, the JSON objects from the semantic analyzer to a condition simulator; and
pass, by the computer, the infrastructure model from the condition simulator to a cost estimator.

10. The computer program product of claim 7, wherein the information of the template comprises constructs of resources, parameters, conditions, and auto scaling, wherein the resources define computing resources, the parameters pass values to the template during runtime, the conditions define whether certain ones of the resources are created, and the auto scaling ensures a correct number of instances available.

11. The computer program product of claim 10, wherein the resources comprises instances, compute, network, and volume.

12. The computer program product of claim 10, wherein the parameters comprise a VM CPU count, VM memory, and VM disk size.

13. A computer system for predicting cost of an infrastructure stack described in a template, the computer system comprising:
one or more processors, one or more computer readable tangible storage devices, and program instructions stored on at least one of the one or more computer readable tangible storage devices for execution by at least one of the one or more processors, the program instructions executable to:
receive from a user, by a computer, the template, the template describing the infrastructure stack;
analyze, by the computer, information in the template;
map, by the computer, the information to a set of attributes;
simulate, by the computer, an infrastructure model depicting the infrastructure stack, based on the attributes;
apply, by the computer, a predefined costing model to the infrastructure model; and
produce, by the computer, estimated billing for the cost of the infrastructure stack, ahead of provisioning the infrastructure stack.

14. The computer system of claim 13, further comprising the program instructions executable to:
scan, by the computer, the template;
checking, by the computer, grammar and syntax errors in the template; and
read, by the computer, input parameters, resources, a conditional construct, and an auto scaling construct in the template.

15. The computer system of claim 13, further comprising the program instructions executable to:
build, by the computer, a parse tree including the attributes;
pass, by the computer, the parse tree from a template parser to a semantic analyzer;
extract, by the computer, the attributes from the parse tree;
build, by the computer, JSON objects with the attributes and values thereof;
pass, by the computer, the JSON objects from the semantic analyzer to a condition simulator; and
pass, by the computer, the infrastructure model from the condition simulator to a cost estimator.

16. The computer system of claim 13, wherein the information of the template comprises constructs of resources, parameters, conditions, and auto scaling, wherein the resources define computing resources, the parameters pass values to the template during runtime, the conditions define whether certain ones of the resources are created, and the auto scaling ensures a correct number of instances available.

17. The computer system of claim 16, wherein the resources comprises instances, compute, network, and volume.

18. The computer system of claim 16, wherein the parameters comprise a VM CPU count, VM memory, and VM disk size.
